(19) United States
(12) Patent Application Publication
(10) Pub. No.: US 2025/0328812 A1
(43) Pub. Date: Oct. 23, 2025

(54) CONVERSION OF QUANTITATIVE ENGINES TO FUZZY QUALITATIVE ENGINES

(71) Applicant: INTERNATIONAL BUSINESS MACHINES CORPORATION, ARMONK, NY (US)

(72) Inventors: Summere Smith, Kansas City, MO (US); Zachary A. Silverstein, Georgetown, TX (US); Logan Bailey, Atlanta, GA (US); Jeremy R. Fox, Georgetown, TX (US)

(21) Appl. No.: 18/640,364

(22) Filed: Apr. 19, 2024

(51) Int. Cl. G06N 20/00

(52) U.S. Cl. CPC G06N 20/00

(57) ABSTRACT

An embodiment for converting quantitative engines to fuzzy qualitative engines is provided. The embodiment may include receiving one or more payloads including one or more data values. The embodiment may also include processing one or more quantitative values in the received one or more payloads. The embodiment may further include executing a table mapping between the processed one or more quantitative values and one or more qualitative values. The embodiment may also include training a rule engine with the table mapping as a first input to the rule engine.

### BACKGROUND

The present invention relates generally to the field of computing, and more particularly to a system for converting quantitative engines to fuzzy qualitative engines.

Currently rules engines are very strongly quantitative or Al based with fuzzy logic. A rule explicitly expects structured values. Alternatively, the rule expects unstructured values. In certain domains, rules engines may require the flexibility to handle judgment calls and/or develop flexibility around a quantitative rule.

### SUMMARY

According to one embodiment, a method, computer system, and computer program product for converting quantitative engines to fuzzy qualitative engines is provided. The method, computer system, and computer program product may include receiving one or more payloads including one or more data values. The method, computer system, and computer program product may also include processing one or more quantitative values in the received one or more payloads. The method, computer system, and computer program product may further include executing a table mapping between the processed one or more quantitative values and one or more qualitative values. The method, computer system, and computer program product may also include training a rule engine with the table mapping as a first input to the rule engine.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for converting quantitative engines to fuzzy qualitative engines in a quantitative engine conversion process according to at least one embodiment.

FIG. 3 is an exemplary diagram depicting an interaction between solution components of the process in FIG. 2 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for converting quantitative engines to fuzzy qualitative engines. The following described exemplary embodiments provide a system, method, and program product to, among other things, execute a table mapping between processed one or more quantitative values and one or more qualitative values and, accordingly, translate at least one qualitative value into a corresponding quantitative value based on the table mapping. Therefore, the present embodiment has the capacity to improve computers by providing increased flexibility to process both qualitative and quantitative user requests.

As previously described, currently rules engines are very strongly quantitative or Al based with fuzzy logic. A rule explicitly expects structured values. Alternatively, the rule expects unstructured values. In certain domains, rules engines may require the flexibility to handle judgment calls and/or develop flexibility around a quantitative rule. However, these rules engines do not have the required flexibility. This problem is typically addressed by processing only standard quantitative user requests. However, processing only standard quantitative user requests fails to provide the flexibility to handle both qualitative and quantitative user requests.

It may, therefore, be imperative to provide a method, system, and computer program product for providing the flexibility to handle both qualitative and quantitative user requests. Thus, embodiments of the present invention may provide advantages including, but not limited to, providing increased flexibility to process both qualitative and quantitative user requests, making a rules engine dual use, and fleshing out rules engines to better handle the jump from quantitative to qualitative engines. The present invention does not require that all advantages need to be incorporated into every embodiment of the invention.

According to at least one embodiment, when processing user requests, an opt-in from the user and one or more payloads including one or more data values may be received in order to process one or more quantitative values in the received one or more payloads. Upon processing the one or more quantitative values, a table mapping may be executed between the processed one or more quantitative values and one or more qualitative values so that a rule engine may be trained with the table mapping as a first input to the rule engine.

According to at least one other embodiment, a query may be received from the user such that it may be determined whether the query contains at least one qualitative value. Based on determining the query contains the at least one qualitative value, the at least one qualitative value may be translated into a corresponding quantitative value based on the table mapping. Then, a response to the query may be outputted, by the rule engine, by processing the corresponding quantitative value.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to execute a table mapping between processed one or more quantitative values and one or more qualitative values and, accordingly, translate at least one qualitative value into a corresponding quantitative value based on the table mapping.

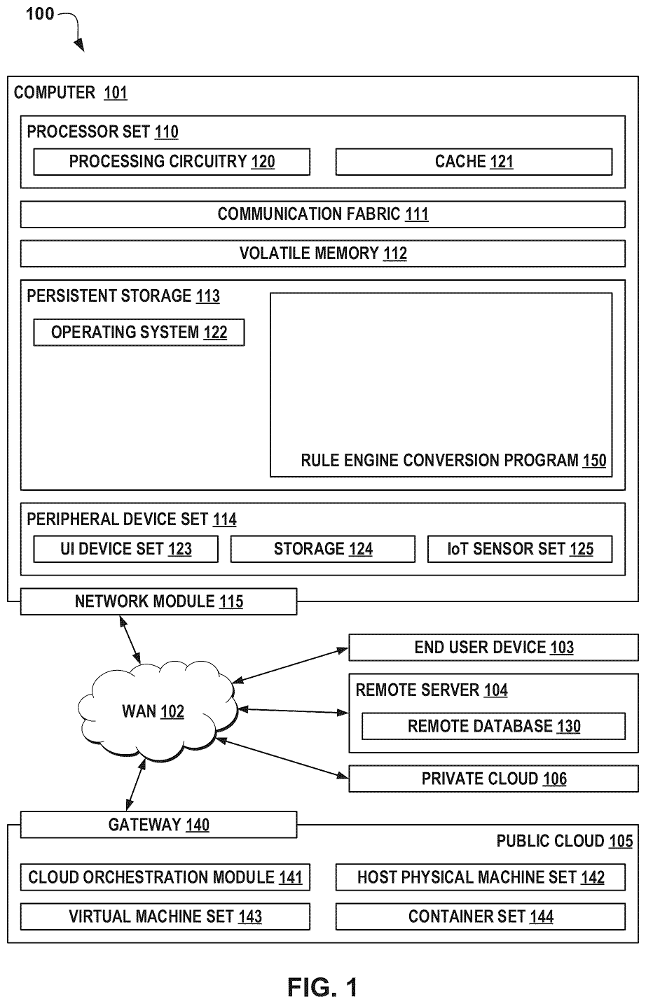

Referring to FIG. 1, an exemplary computing environment 100 is depicted, according to at least one embodiment. Computing environment 100 contains an example of an environment for the execution of at least some of the computer code involved in performing the inventive methods, such as a rule engine conversion program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

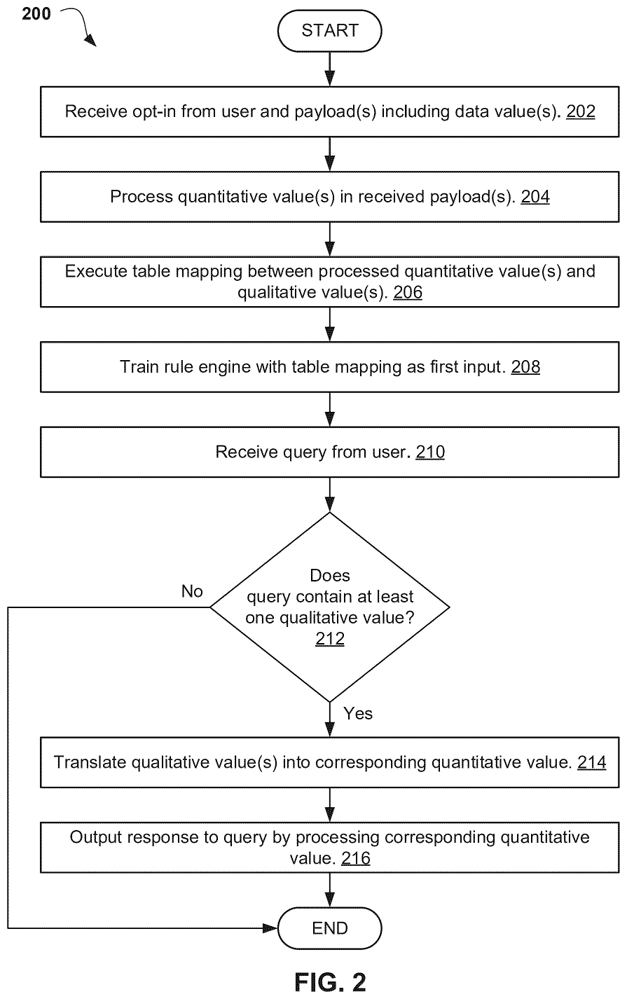

According to the present embodiment, the rule engine conversion program 150 may be a program capable of receiving an opt-in from a user and one or more payloads including one or more data values, executing a table mapping between processed one or more quantitative values and one or more qualitative values, translating at least one qualitative value into a corresponding quantitative value based on the table mapping, providing increased flexibility to process both qualitative and quantitative user requests, making a rules engine dual use, and fleshing out rules engines to better handle the jump from quantitative to qualitative engines. Furthermore, notwithstanding depiction in computer 101, the rule engine conversion program 150 may be stored in and/or executed by, individually or in any combination, end user device 103, remote server 104, public cloud 105, and private cloud 106. The rule engine conversion method is explained in further detail below with respect to FIG. 2. It may be appreciated that the examples described below are not intended to be limiting, and that in embodiments of the present invention the parameters used in the examples may be different.

Referring now to FIG. 2, an operational flowchart for converting quantitative engines to fuzzy qualitative engines in a quantitative engine conversion process 200 is depicted according to at least one embodiment. At 202, the rule engine conversion program 150 receives the opt-in from the user and the one or more payloads including the one or more data values. As used herein, the “user” is either an end user or any system interfacing with the rule engine. The user may opt-in via a graphical user interface (GUI) on a device of the user, such as end user device 103. When the user opts-in, any request of the user may be handled by the rule engine.

The invention module (e.g., the rule engine conversion program 150) may co-reside with the rule engine to ingest inbound payloads. For example, the invention module and the rule engine may co-habitate in containers deployed in a similar environment. The one or more payloads may include multiple types. According to at least one embodiment, the one or more data values may include live data. According to at least one other embodiment, the one or more data values may include simulation data. In either embodiment, the one or more data values may include qualitative data and/or quantitative data. For example, a payload relating to a credit limit may be a quantitative value, whereas a payload relating to a loan decision may be a qualitative value.

Then, at 204, the rule engine conversion program 150 processes the one or more quantitative values in the received one or more payloads. In particular, the rule engine conversion program 150 may utilize the rule engine to process the one or more quantitative values. The rule engine may be ingested in a known format such as .dmn or .dri.

According to at least one embodiment, an AI module may process the one or more quantitative values. The AI module may be a large language model (LLM) or a generative pre-trained transformer (GPT). For example, numerical values in the received one or more payloads may be processed by the rule engine. Continuing the example, where the payload relates to the credit limit, a credit limit of $20,000 may be processed by the rule engine. The one or more quantitative values may be processed alone when the one or more payloads only include live quantitative data.

According to at least one other embodiment, processing the one or more quantitative values may also include processing one or more qualitative values in the received one or more payloads. In this embodiment, the one or more payloads may include simulation data containing both qualitative and quantitative data. Alternatively, the one or more payloads may include live quantitative data and live qualitative data.

Next, at 206, the rule engine conversion program 150 executes the table mapping between the processed one or more quantitative values and the one or more qualitative values. The table mapping may be executed based on the types of data included in the one or more payloads.

According to at least one embodiment, based on determining, by the rule engine, that the one or more data values include simulation data, the table mapping may be executed the processed one or more quantitative values and the one or more qualitative values in the simulation data. For example, a qualitative value “good” in the simulation data may be mapped to a quantitative value in the simulation data such as a sentiment score of 0.7. As used herein, “simulation data” is data that is artificially generated.

According to at least one other embodiment, based on determining, by the rule engine, that the one or more data values include a live quantitative value and a live qualitative value, the table mapping may be executed between the live quantitative value and the live qualitative value. For example, a qualitative value “great” in the live data may be mapped to a quantitative value in the live data such as a sentiment score of 0.8. As used herein, “live data” is data that is not artificially generated.

According to at least one further embodiment, based on determining, by the rule engine, that the one or more data values include a live quantitative value and no qualitative value, the LLM or GPT may ingest the live quantitative value. The LLM or GPT may then generate a live qualitative value corresponding to the live quantitative value.

The corresponding live qualitative value may be generated based on a conversion factor. Specifically, the LLM or GPT may transform the live quantitative value into the corresponding live qualitative value utilizing a standardized scale such as sentiment scoring. For example, when a rule specifies that a sentiment score is to be greater than or equal to 0.7, a corresponding live qualitative value that may be generated may be “good.” In another example, when a rule specifies that a sentiment score is to be less than or equal to 0.3, a corresponding live qualitative value that may be generated may be “bad.” Upon generating the live qualitative value corresponding to the live quantitative value, the table mapping may be executed between the live qualitative value and the live quantitative value. For example, “good” may be mapped to 0.7. In another example, “bad” may be mapped to 0.3.

Then, at 208, the rule engine conversion program 150 trains the rule engine with the table mapping as a first input to the rule engine. For example, assuming the table mapping includes the qualitative value “good” mapped to the quantitative value of 0.7 and the qualitative value “bad” mapped to the quantitative value of 0.3, the rule engine may be trained on the table mapping containing these values.

According to at least one embodiment, training the rule engine may also include creating a fuzzy logic threshold of acceptance for the rule engine. The fuzzy logic threshold of acceptance may be agreed upon by the organization deploying the rule engine. For example, the fuzzy logic threshold of acceptance may be 85%-90%. A string to pseudo-sentiment transversal may be executed on a first qualitative value and a second qualitative value, where the first qualitative value may include a fuzzy logic expected value. For example, the qualitative value “good” may have a fuzzy logic expected value of 0.7. However, it may be appreciated that in embodiments of the present invention, words may be misspelled, abbreviated, or have characters omitted. Thus, the second qualitative value may be a misspelled or abbreviated word and/or have characters omitted. For example, the second qualitative value may be the word “grate.” Then, a fuzzy logic score may be generated for the second qualitative value based on the string to pseudo-sentiment transversal. For example, the fuzzy logic score for “grate” may be 90%. Based on determining that the fuzzy logic score is within the fuzzy logic threshold of acceptance, the fuzzy logic expected value may be assigned to the second qualitative value. Continuing the example, since 90% is within the fuzzy logic threshold of acceptance, “grate” may also be assigned the fuzzy logic expected value of 0.7. According to at least one other embodiment, based on determining that the fuzzy logic score is not within the fuzzy logic threshold of acceptance, the fuzzy logic expected value may not be assigned to the second qualitative value, and the second qualitative value may be sent to a separate entity, such as the organization manager, for manual processing.

According to at least one further embodiment, one or more test cases may be used to validate the training of the rule engine. The one or more test cases may include live data or simulation data relating to potential requests that may be made by the user. Depending on how the rule engine performs, the table mapping may be updated or no changes may be made.

Next, at 210, the rule engine conversion program 150 receives the query from the user. The user may submit the query via the GUI on the device of the user, such as end user device 103. The query may include completely unstructured text. Alternatively, the query may include partially unstructured (e.g., qualitative) text and partially structured (e.g., quantitative) extractable values through LLM or GPT understanding, described in further detail below with respect to step 214. For example, the query may relate to finding products on a website with positive reviews.

Then, at 212, the rule engine conversion program 150 determines whether the query contains the at least one qualitative value. The rule engine may utilize natural language processing (NLP) to determine whether the query contains the at least one qualitative value. For example, the query may be, “Find me a product with at least a good consumer review.” In this example, the word “good” may be the at least one qualitative value.

In response to determining the query contains the at least one qualitative value (step 212, “Yes” branch), the quantitative engine conversion process 200 proceeds to step 214 to translate the at least one qualitative value into the corresponding quantitative value. In response to determining the query does not contain the at least one qualitative value (step 212, “No” branch), the quantitative engine conversion process 200 ends.

Next, at 214, the rule engine conversion program 150 translates the at least one qualitative value into the corresponding quantitative value. The at least one qualitative value is translated based on the table mapping. For example, where the at least one qualitative value is “good,” and where the table mapping indicates the quantitative value for “good” is 0.7, the qualitative value “good” may be translated into the quantitative value 0.7.

According to at least one embodiment, translating the at least one qualitative value into the corresponding quantitative value may also include extracting one or more structured values from the received query. For example, the query may be, “Find me a product under $50 with at least a good consumer review.” In this example, $50 may be the extracted one or more structured values. The extracted one or more structured values may be converted, by the LLM or GPT, into one or more unstructured values. For example, the structured value $50 may be converted into unstructured text, such as “expensive.” An updated table mapping may be executed between the extracted one or more structured values and the one or more unstructured values. For example, the structured value $50 and the unstructured value “expensive” may be mapped and added to the table mapping to create the updated table mapping. Then, the rule engine may be retrained with the updated table mapping as a second input to the rule engine. In this manner, the rule engine becomes better equipped to handle unstructured requests with each successive iteration.

Then, at 216, the rule engine conversion program 150 outputs the response to the query by processing the corresponding quantitative value. For example, where the query is, “Find me a product with at least a good consumer review,” the rule engine may process the corresponding quantitative value for the text “good.” Continuing the example, the corresponding quantitative value for the text “good” may be 0.7 based on the table mapping. The outputted response may include sending the user a list of products that fit the criteria determined based on the corresponding quantitative value.

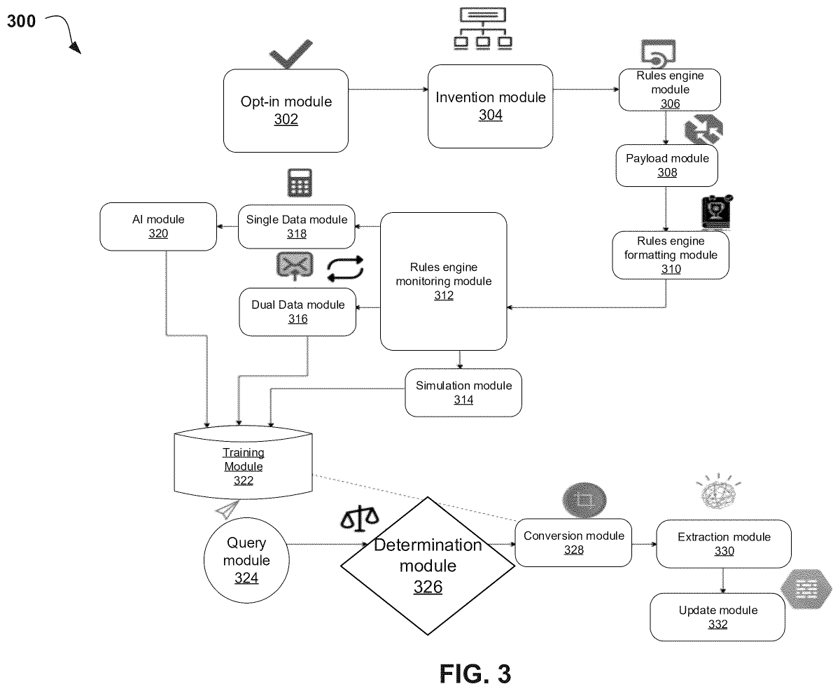

Referring now to FIG. 3, an exemplary diagram 300 depicting an interaction between solution components of the process in FIG. 2 is shown according to at least one embodiment. In the diagram 300, the opt-in module 302 may receive the opt-in from the user. The invention module 304 may be deployed on a desired platform and infrastructure set by the user. The rules engine module 306 may deploy the rule engine in a same container as the invention module. The payload module 308 may ingest payloads of multiple types. The rules engine formatting module 310 may ingest the rule engine in a known format. For example, the rule engine may be ingested in a known format such as .dmn or .dri. The rules engine monitoring module 312 may monitor for live data and simulation data. The simulation module 314 may map quantitative values and qualitative values in the simulation data. The dual data module 316 may map quantitative values and qualitative values in the live data. The single data module 318 may receive quantitative values in the live data. The AI module 320 may apply the conversion factor to transform the quantitative values to the qualitative values. The training module 322 may train the rule engine with the table mappings and validate the training of the rule engine.

The query module 324 may receive the query from the user from the GUI. The determination module 326 may apply NLP to determine whether the query contains the at least one qualitative value. The conversion module 328 may convert and transform the qualitative values into the quantitative values. The extraction module 330 may extract the structured values from the received query. Finally, the update module 332 may execute the updated table mapping between the extracted structured values and the unstructured values that may be used to retrain the rule engine.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of converting quantitative engines to fuzzy qualitative engines, the method comprising:
receiving one or more payloads including one or more data values;
processing one or more quantitative values in the received one or more payloads;
executing a table mapping between the processed one or more quantitative values and one or more qualitative values; and
training a rule engine with the table mapping as a first input to the rule engine.

2. The computer-based method of claim 1, further comprising:
receiving a query from a user;
determining whether the query contains at least one qualitative value;
based on determining the query contains the at least one qualitative value, translating the at least one qualitative value into a corresponding quantitative value based on the table mapping; and
outputting, by the rule engine, a response to the query by processing the corresponding quantitative value.

3. The computer-based method of claim 2, wherein translating the at least one qualitative value into the corresponding quantitative value further comprises:
extracting one or more structured values from the received query;
converting, by a generative pre-trained transformer, the extracted one or more structured values into one or more unstructured values;
executing an updated table mapping between the extracted one or more structured values and the one or more unstructured values; and
retraining the rule engine with the updated table mapping as a second input to the rule engine.

4. The computer-based method of claim 1, wherein executing the table mapping further comprises:
based on determining, by the rule engine, that the one or more data values include simulation data, executing the table mapping between the processed one or more quantitative values and the one or more qualitative values in the simulation data.

5. The computer-based method of claim 1, wherein executing the table mapping further comprises:
based on determining, by the rule engine, that the one or more data values include a live quantitative value and a live qualitative value, executing the table mapping between the live quantitative value and the live qualitative value.

6. The computer-based method of claim 1, wherein executing the table mapping further comprises:
based on determining, by the rule engine, that the one or more data values include a live quantitative value, ingesting, by a large language model, the live quantitative value;
generating a live qualitative value corresponding to the live quantitative value; and
executing the table mapping between the live qualitative value and the live quantitative value.

7. The computer-based method of claim 1, wherein training the rule engine further comprises:
creating a fuzzy logic threshold of acceptance for the rule engine;
executing a string to pseudo-sentiment transversal on a first qualitative value and a second qualitative value, wherein the first qualitative value includes a fuzzy logic expected value;
generating a fuzzy logic score for the second qualitative value based on the string to pseudo-sentiment transversal; and
based on determining the fuzzy logic score is within the fuzzy logic threshold of acceptance, assigning the fuzzy logic expected value to the second qualitative value.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving one or more payloads including one or more data values;
processing one or more quantitative values in the received one or more payloads;
executing a table mapping between the processed one or more quantitative values and one or more qualitative values; and
training a rule engine with the table mapping as a first input to the rule engine.

9. The computer system of claim 8, the method further comprising:
receiving a query from a user;
determining whether the query contains at least one qualitative value;
based on determining the query contains the at least one qualitative value, translating the at least one qualitative value into a corresponding quantitative value based on the table mapping; and
outputting, by the rule engine, a response to the query by processing the corresponding quantitative value.

10. The computer system of claim 9, wherein translating the at least one qualitative value into the corresponding quantitative value further comprises:
extracting one or more structured values from the received query;
converting, by a generative pre-trained transformer, the extracted one or more structured values into one or more unstructured values;
executing an updated table mapping between the extracted one or more structured values and the one or more unstructured values; and
retraining the rule engine with the updated table mapping as a second input to the rule engine.

11. The computer system of claim 8, wherein executing the table mapping further comprises:
based on determining, by the rule engine, that the one or more data values include simulation data, executing the table mapping between the processed one or more quantitative values and the one or more qualitative values in the simulation data.

12. The computer system of claim 8, wherein executing the table mapping further comprises:
based on determining, by the rule engine, that the one or more data values include a live quantitative value and a live qualitative value, executing the table mapping between the live quantitative value and the live qualitative value.

13. The computer system of claim 8, wherein executing the table mapping further comprises:
based on determining, by the rule engine, that the one or more data values include a live quantitative value, ingesting, by a large language model, the live quantitative value;
generating a live qualitative value corresponding to the live quantitative value; and
executing the table mapping between the live qualitative value and the live quantitative value.

14. The computer system of claim 8, wherein training the rule engine further comprises:
creating a fuzzy logic threshold of acceptance for the rule engine;
executing a string to pseudo-sentiment transversal on a first qualitative value and a second qualitative value, wherein the first qualitative value includes a fuzzy logic expected value;
generating a fuzzy logic score for the second qualitative value based on the string to pseudo-sentiment transversal; and
based on determining the fuzzy logic score is within the fuzzy logic threshold of acceptance, assigning the fuzzy logic expected value to the second qualitative value.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving one or more payloads including one or more data values;
processing one or more quantitative values in the received one or more payloads;
executing a table mapping between the processed one or more quantitative values and one or more qualitative values; and
training a rule engine with the table mapping as a first input to the rule engine.

16. The computer program product of claim 15, the method further comprising:
receiving a query from a user;
determining whether the query contains at least one qualitative value;
based on determining the query contains the at least one qualitative value, translating the at least one qualitative value into a corresponding quantitative value based on the table mapping; and
outputting, by the rule engine, a response to the query by processing the corresponding quantitative value.

17. The computer program product of claim 16, wherein translating the at least one qualitative value into the corresponding quantitative value further comprises:
extracting one or more structured values from the received query;
converting, by a generative pre-trained transformer, the extracted one or more structured values into one or more unstructured values;
executing an updated table mapping between the extracted one or more structured values and the one or more unstructured values; and
retraining the rule engine with the updated table mapping as a second input to the rule engine.

18. The computer program product of claim 15, wherein executing the table mapping further comprises:
based on determining, by the rule engine, that the one or more data values include simulation data, executing the table mapping between the processed one or more quantitative values and the one or more qualitative values in the simulation data.

19. The computer program product of claim 15, wherein executing the table mapping further comprises:
based on determining, by the rule engine, that the one or more data values include a live quantitative value and a live qualitative value, executing the table mapping between the live quantitative value and the live qualitative value.

20. The computer program product of claim 15, wherein executing the table mapping further comprises:
based on determining, by the rule engine, that the one or more data values include a live quantitative value, ingesting, by a large language model, the live quantitative value;
generating a live qualitative value corresponding to the live quantitative value; and
executing the table mapping between the live qualitative value and the live quantitative value.
